(19) United States
(12) Patent Application Publication
(10) Pub. No.: US 2012/0259806 A1
(43) Pub. Date: Oct. 11, 2012

(54) User as a Service

(76) Inventors: Balakumaran Balabaskaran, Kirkland, WA (US); Charles Prakash Dasari, Redmond, WA (US)

(21) Appl. No.: 13/084,417

(22) Filed: Apr. 11, 2011

(51) Int. Cl. G06N 5/02

(52) U.S. Cl. 706/47

(57) ABSTRACT

Techniques are disclosed for allowing a user to configure profiles to permit interactions with the user based upon varying factors, such as location, mood, time, who the user is with, who is trying to communicate with the user, and other factors. By using a dynamic user profile, the user obtains more control over how and when other people may interact with the user, and how the user interacts with other people.

### FIELD

The present application relates to obtaining data pertaining to a user from various sources, and making it available for processing after normalizing.

### BACKGROUND

As social media sites and other forms of electronic communication become more popular, it takes more and more time for people to keep up with their friends. Checking Facebook, MySpace, Twitter, email, getting phone calls on cell phones, text messaging, and other sites and means of communication can interfere with other activities.

### SUMMARY

The instant application describes ways to obtain data from various sources such a social networks, mobile devices, email, or other software, services, or hardware relating to a user, allowing the user to control how and when he receives the data. By obtaining data pertaining to the user, a richer experience may be available, providing information gathered from a plurality of sources. The user may set preferences based on the information from multiple sources at once, so that, by way of example and not limitation, the user may prefer that if she is at work based upon information from her cell phone, and that she is meeting some friends after work based upon information from Facebook, that if anyone wishes to contact her about the place they are meeting via e-mail, her email should automatically generate a response that she will contact the person after work to provide details. This ability to use multiple sources at the same time may provide the user with more control over how he interacts with others and how and when others may interact with him, improving the overall experience.

Once the data is obtained, it may be normalized to an XML, JSON, or other formats, which may then be processed by a rules engine which may allow the user to determine how to deal with the data based on context or the user's present situation.

One skilled in the art will recognize that many types of information could be normalized and used for further processing in a consistent manner, and that various formats could be used for the normalized format of the data.

### BRIEF DESCRIPTION OF THE OF THE DRAWINGS

These and other features and advantages of User as a Service will now be described with reference to drawings of certain embodiments, which are intended to illustrate and not to limit the instant application:

FIG. 1 is an example of a system in which one embodiment of User as a Service techniques may be implemented;

FIG. 2 is an example of one embodiment of an event illustrating the parts of an event as normalized;

FIG. 3 illustrates a diagram of possible sources for an event according to one embodiment;

FIG. 4 is an example of one embodiment of possible components to an event header;

FIG. 5 is an example of one embodiment of information that may create an Online Personality for a user.

FIG. 6 illustrates an example embodiment for tracking a person of interest to a user.

FIG. 7 illustrates an example of how to use an online persona in one embodiment.

FIG. 8 illustrates a component diagram of a computing device according to one embodiment.

### DETAILED DESCRIPTION

The instant application describes ways to obtain data from various sources such a social networks, mobile devices, email, or other software, services, or hardware relating to a user, allowing the user to control how and when he receives the data. By obtaining data pertaining to the user, a richer experience may be available, providing information gathered from a plurality of sources to be used in conjunction with each other.

In one embodiment, the data may contain information such as:

(1) Knowledge—what a user knows, or what others know about the user.

(2) Behavior—how the user reacts to stimuli; for example, how does the user react to something that is presented to them online?

(3) Context—a scenario or situation under which the user is interacting online. This includes a number of factors, but things like location, mood, and other people with whom they are interacting—or even things like the current weather conditions—could provide context relevant to the user.

(4) Stimuli—an activity or event that occurs in a context to which the user may react. For example, an ad displayed at home while the user is relaxed may provoke a different reaction from them than an ad displayed while at work. Someone contacting the user at home may elicit a completely different reaction from them than someone trying to reach the user at work.

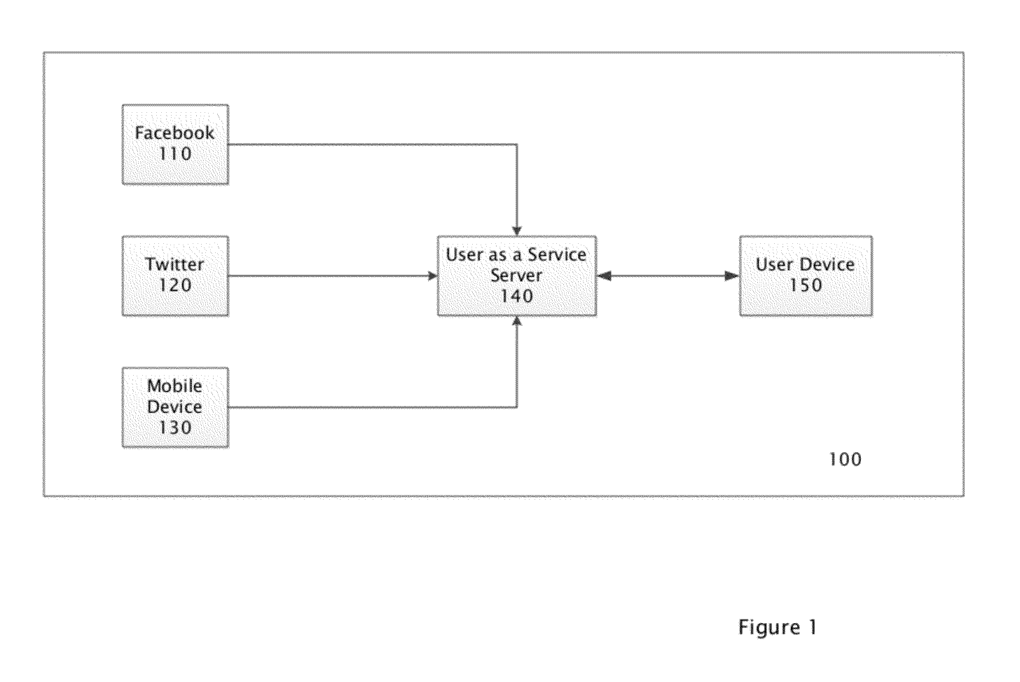

FIG. 1 is an example of a system (100) in which one embodiment of User as a Service techniques may be implemented. Various sources, such as Facebook (110), Twitter (120), email, other social networks, a Mobile Device (130), or other sources may provide data to a User as a Service Server (140), which may be configured by a user to apply rules to the data, and provide the user with appropriate information to determine how to respond to events from the various sources.

In this embodiment, for example, if a Mobile Device (130) indicates that a user is at work based on GPS coordinates, and that it is work hours based on a calendar, the User as a Service Server (140) may provide an alert to the user if a work-related email arrives. The user may also configure the User as a Service Server (140) to filter personal emails during work hours, and only present them after work, or at particular times during the work day. The user may configure the User as a Service Server (140) to respond in various ways depending on any combination of data from the various sources the user configures the User as a Service Server (140) to track.

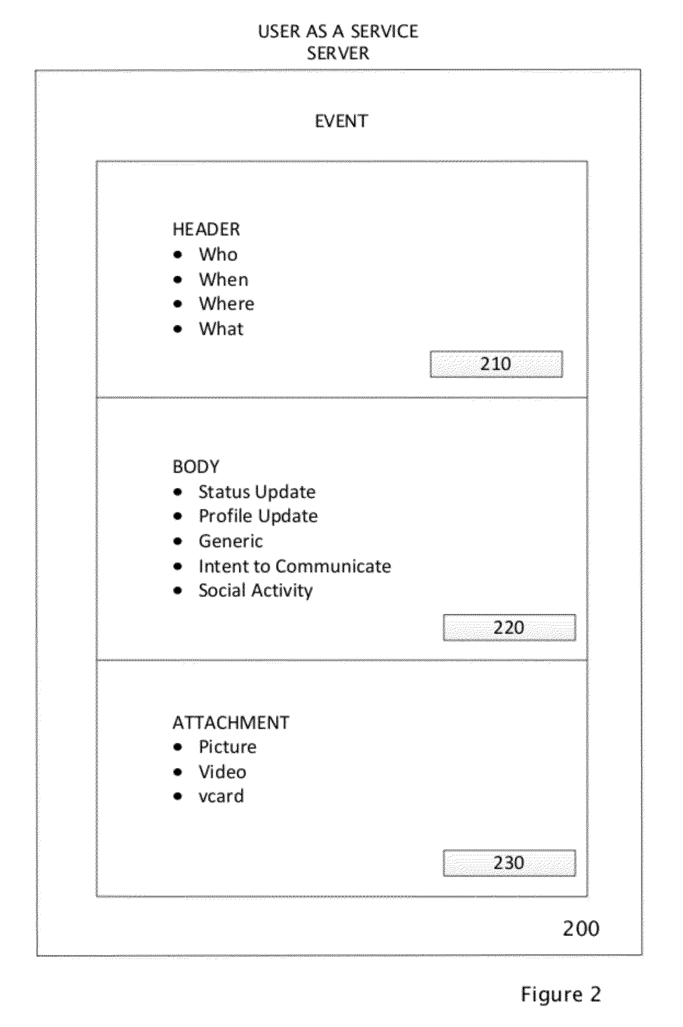

In one embodiment, the User as a Service Server (140) polls the various sources, checking on a regular schedule to see if there are new status updates from a user, for example. Each update the user has selected to act upon is normalized into an event (200), as shown in FIG. 2, which may be processed by a rule processor. For example, Facebook (110) may be polled for status updates from the user or other people or identities in which the user is interested, Twitter (120) may be polled for new Tweets from people the user follows, a Mobile Device (130) may be polled for current GPS coordinates, a text message source may be polled for received text messages, email may be polled to check for new email, including information on who it is from, its priority, and so on. Other methods besides polling may also be used to obtain data from the various sources; by way of an example and not by limitation, a mobile device may push data to the User as a Service Server. One skilled in the art will appreciate that many other social networks, devices, applications, and other sources may be used to obtain data that may be of interest to the user.

In one embodiment, a user may configure a User as a Service Server (140) to notify a friend via email that the user is in a meeting if the friend tries to call during time indicating a meeting based on the user's calendar.

In another embodiment, a user may configure a User as a Service Server (140) by generating rules to process events obtained from various sources. These rules may take a form such as On < event> When <status> Then <action>. For example, a rule may be represented as: “On new voicemail at home from my family; when I am at work; then transcribe and email me the message.” A rule such as this may be generated by a configuration application to simplify rule generation for the user in one embodiment.

FIG. 2 is an example of one embodiment of an event (200) illustrating the parts of an event. The event in this embodiment comprises a Header (210), a Body (220), and an Attachment (230).

By way of example and not limitation, if someone tagged a user in a picture on Facebook (110), an event (200) may be generated. A header (210) may include semantic information, such as who, when, where, and what. Who, in this example, may include who posted the picture. What may include information such as: 1) that it is a picture, 2) that the picture is in a JPEG format, and 3) other information of interest about the picture. When may contain the time the picture was posted. If the event was an email, when may contain a time sent and an expiry time. Where may contain the location the picture was taken, where the picture was located, or both. One skilled in the art will realize that different types of events may have more or less information stored in a header, and that the data stored may vary from event to event.

A body (220) may include the information contained in the event (200). Continuing with the previous example, the body (220) may include the picture on Facebook (110) with the user tagged. Other examples of items the body (220) may contain include a status update, a profile update, an email, an intent to communicate, a social activity, or generic information if the information of interest may be contained in the header (210) or the attachment (230).

Attachment (230) may contain a picture, an email, or any other information related to the event (200).

In one embodiment, the event (200) would be represented in an XML format.

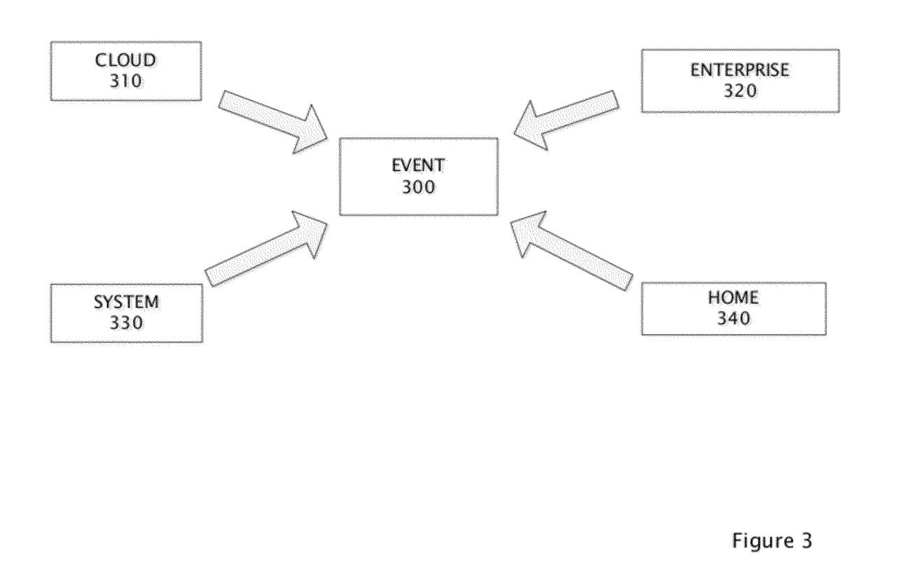

FIG. 3 illustrates a diagram of possible sources for an event (300) according to one embodiment. The cloud (310) may provide events (300) from services, from web sites, or from other users. An enterprise (320) may also provide events (300) from services, from web sites, or from other users, as well as from line of business applications. Events (300) may be provided from home (340), again including from services, and also from devices or applications. Additionally, the user as a service system (330) may generate events from a scheduler or when errors occur.

These sources of events are examples only, and one skilled in the art will recognize that other sources may provide events and many different types of events may be of interest to a user and thus used by the system.

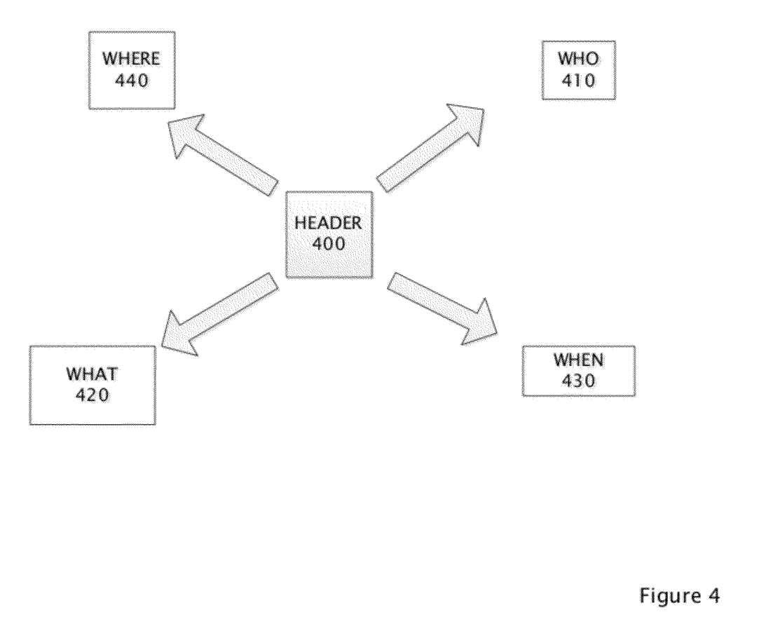

FIG. 4 is an example of one embodiment of possible components for an event header (400). A header (400) may include information about who (410), what (420), when (430), and where (440) about the event.

Who (410) may include such information as who the event is from (who sent a tweet, for example), who it was sent to (in the case of an email, for example), and who it is about (in a picture tagged in Facebook, for example). Any information concerning the people involved in an event may be included.

What (420) may include reference information, a subject, category, culture, content type, and the importance of the event.

When (430) may include information such as starting and ending times, duration, a validity period, or other information related to times and dates of the event.

Where (440) may contain information about a location of the source of the event, a location of a subject of the event, the location of the target audience for the event, or other information relating to locations pertaining in some way to the event.

Information for how to process the event (300) may be supplied by a rule. A script engine may work with a structure of a rule using units of code called snippets. A rule may be how the user (500) indicates what actions may happen to different events (300) in conjunction with different contexts or situations. Rules may be normalized, and source code such as C#, Visual Basic, C++, Java or another programming language, may be generated and compiled into a DLL or other form of executable code. This executable code may then be called by the script engine to perform the actions described by the rule. The rule may also be stored in an XML, JSON, or other format which may allow for future editing or recompiling. For example, these rules may take a form such as On < event> When <status> Then <action>.

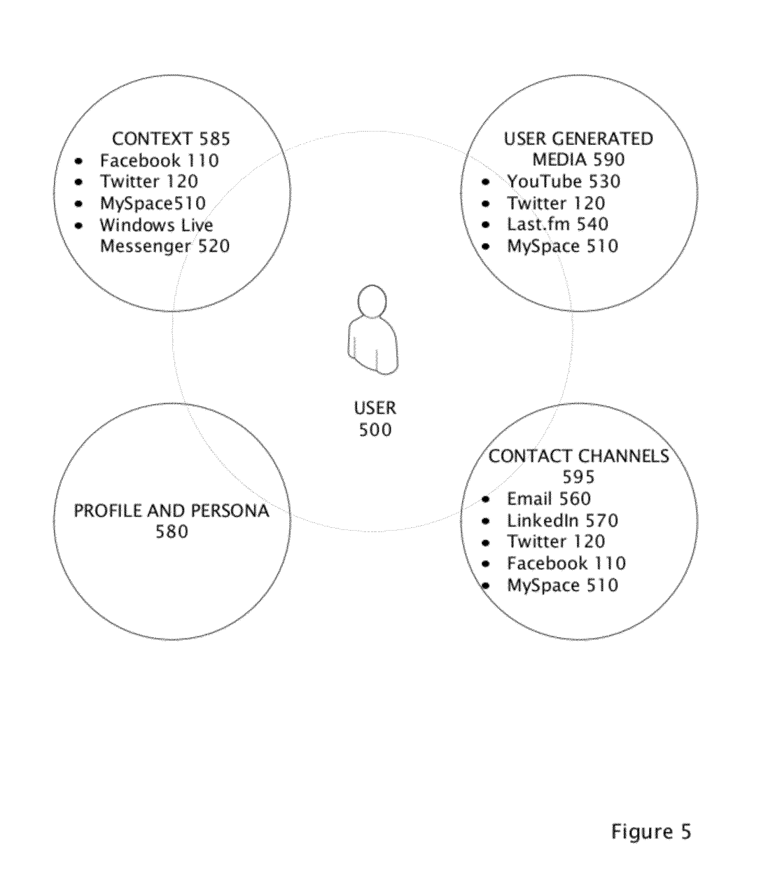

FIG. 5 is an example of one embodiment of information that may create an Online Personality for a user (500). An Online Personality provides how a user wants to be known online. The Online Personality may be determined by the social media content a user generates (590), the information about the user that is exposed from their profile data (580), the means of contact channels (595) the user (500) chooses, as well as context (585) the user (500) shares. Various sources, such as Facebook (110), Twitter (120), email, other social networks, a Mobile Device (130), or other sources may provide data for the determination of the Online Personality.

In one embodiment, the Online Personality data may be provided by context (585) through information coming from various social networking services such as Facebook (110), Twitter (120), MySpace (510), Windows Live Messenger (520), YouTube (530), Last.fm (540), or MySpace (510). For example, User Generated Media (590), such as a YouTube (530) video that is generated by a user (500) and visible to others may provide information which could allow an Online Personality to be created. Another example of how Online Personality may be created is from profile and persona data (580) a user (500) shares such as where they live, what books they like, what sports they are interested in, what kind of car they drive, or any other data a user (500) may share. Additionally, context such as presence, location, mood, or communication mode may also help create the Online Personality as well. The User (500) may also establish different contact channels (595) to create the Online Personality. By way of example, and not limitation, the user (500) may like to be reached in certain situations by Facebook (110), while in other situations the user (500) may prefer to be contacted by LinkedIn (570), Windows Live Messenger (520) or email (560).

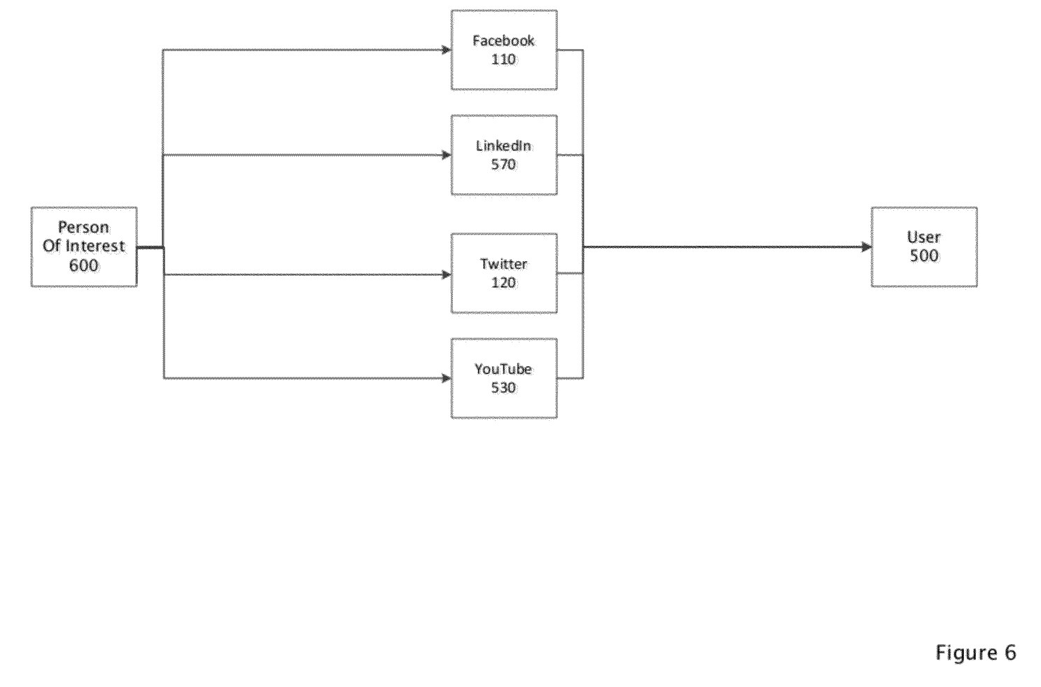

FIG. 6 illustrates an example embodiment for tracking a person of interest (600) to a user (500). A user (500) may want to generate contextual rules around a person of interest (600) and not just around a message from a service. For example, a rule may be represented as: “On new blog post by Ashton Kutcher; then add it to my reading list and send it to my Ashton Kutcher Fan club buddies.” The resulting rule is created around a person of interest (600), in this example, Ashton Kutcher, rather than a rule for each social networking service. A person of interest (600) may be a celebrity, a friend, a coworker, or anyone a user (500) is interested in following.

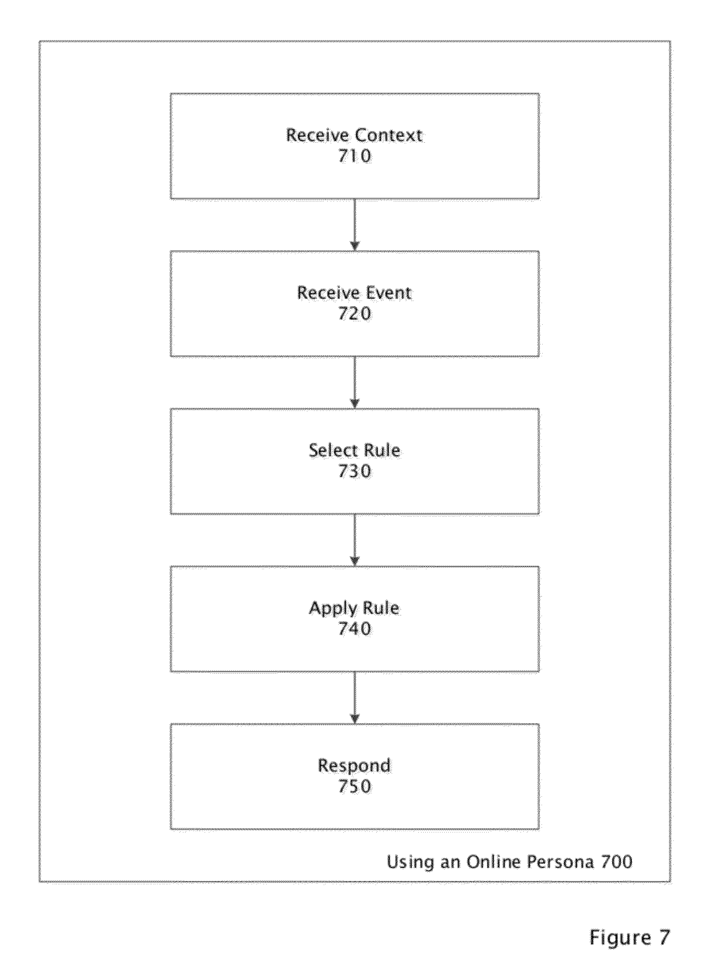

FIG. 7 illustrates an example of how to use an online persona (700) in one embodiment. In this example, context (585) is received (710) from various sources, such as Facebook (110), Twitter (120), Windows Live Messenger (520), or other sources, providing information about how the user (500) wishes to interact with others. An event (300) is received (720), indicating that something that may be of interest to the user (500) has happened. Based upon the context (585) and the event (300), a rule previously configured by the user (500) is selected (730), corresponding to the context (585) and the event (300). The rule is applied (740) to the event, and the event is responded to (750). As an example and not a limitation, the context (585) may indicate that the user (500) is at work. An event may be received (720) that indicates a friend has tagged the user (500) in a photograph on Facebook. The user (500) may have configured a rule to generate a text message to her cell phone when someone tags her in a photo when she is at work, so the corresponding rule will be selected and applied, with the result that a text message will be sent to her phone.

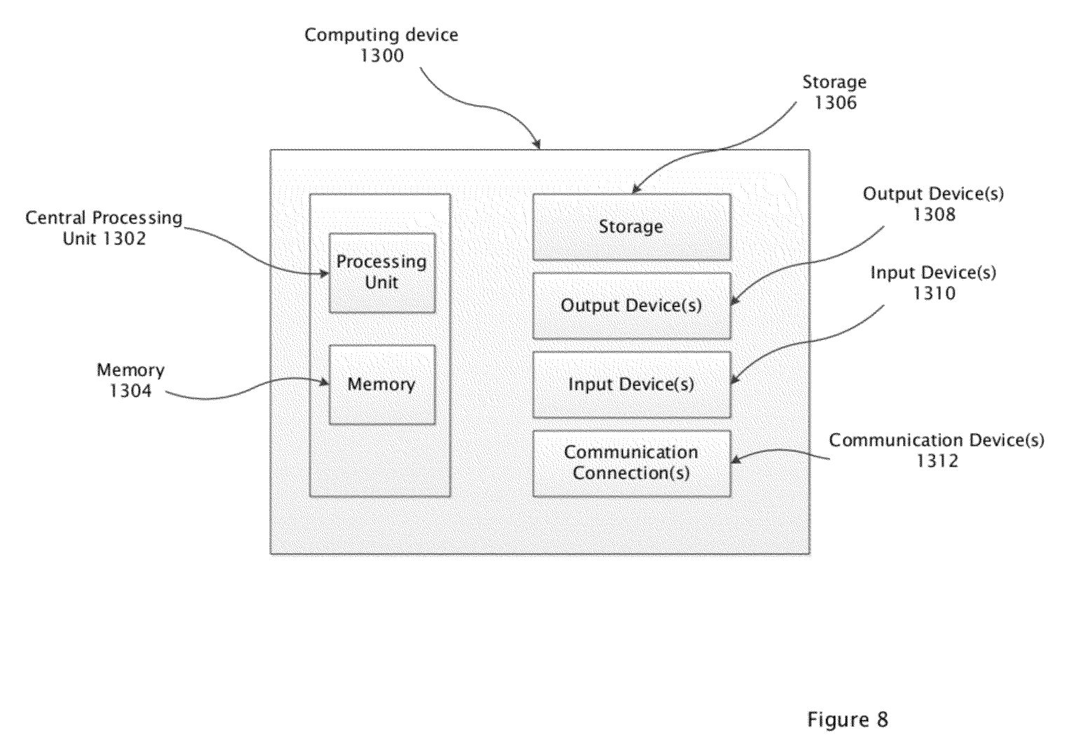

FIG. 8 illustrates a component diagram of a computing device according to one embodiment. The computing device (1300) can be utilized to implement one or more computing devices, computer processes, or software modules described herein. In one example, the computing device (1300) can be utilized to process calculations, execute instructions, receive and transmit digital signals. In another example, the computing device (1300) can be utilized to process calculations, execute instructions, receive and transmit digital signals, receive and transmit search queries, and hypertext, compile computer code as required by a Server (140) or a Client (150). The computing device (1300) can be any general or special purpose computer now known or to become known capable of performing the steps and/or performing the functions described herein, either in software, hardware, firmware, or a combination thereof.

In its most basic configuration, computing device (1300) typically includes at least one central processing unit (CPU) (1302) and memory (1304). Depending on the exact configuration and type of computing device, memory (1304) may be volatile (such as RAM), non-volatile (such as ROM, flash memory, etc.) or some combination of the two. Additionally, computing device (1300) may also have additional features/functionality. For example, computing device (1300) may include multiple CPU's. The described methods may be executed in any manner by any processing unit in computing device (1300). For example, the described process may be executed by both multiple CPU's in parallel.

Computing device (1300) may also include additional storage (removable and/or non-removable) including, but not limited to, magnetic or optical disks or tape. Such additional storage is illustrated in FIG. 8 by storage (1306). Computer storage media includes volatile and nonvolatile, removable and non-removable media implemented in any method or technology for storage of information such as computer readable instructions, data structures, program modules or other data. Memory (1304) and storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing device (1300) may also contain communications device(s) (1312) that allow the device to communicate with other devices. Communications device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device (1300) may also have input device(s) (1310) such as keyboard, mouse, pen, voice input device, touch input device, etc. Output device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

What is claimed is:

1. A method for using an online persona comprising:
receiving a context related to a user;
receiving an event relating to the user;
selecting a rule based on the context and the event;
applying the rule to the event;
responding to the event based on a result of the rule.

2. The method of claim 1 wherein the context comprises the location of the user.

3. The method of claim 1 wherein the context comprises the mood of the user.

4. The method of claim 1 wherein the context comprises the time of day.

5. The method of claim 1 wherein the event comprises an update from a social media source.

6. The method of claim 1 wherein the event comprises an email.

7. The method of claim 1 wherein the event comprises a text message.

8. The method of claim 1 wherein the event comprises a phone call.

9. The method of claim 1 wherein the response comprises an update to a social media source.

10. A computer readable storage media having instructions stored thereon which when executed, execute the method of claim 1.

11. The computer readable storage media of claim 10 wherein the context comprises location of the user and the event comprises a social media update.

12. A system for using an online persona comprising:
a processor;
a memory communicatively connected to the processor;
a context receiving component configured to receive a context related to a user;
an event receiving component configured to receive an event related to a user;
a rule selecting component configured to select a rule based on the context and the event;
a rule applying component configured to apply the rule to the event; and
a response generating component configured to generate a response to the event based on a result of the rule.

13. The system of claim 12 wherein the context receiving component is configured to receive time of day information.

14. The system of claim 12 wherein the context receiving component is configured to receive location information.

15. The system of claim 12 wherein the context receiving component is configured to receive a social media update.

16. The system of claim 12 wherein the event receiving component is configured to receive an email.

17. The system of claim 12 wherein the event receiving component is configured to receive a text message.

18. The system of claim 12 wherein the event receiving component is configured to receive a photo.

19. The system of claim 12 wherein the event receiving component is configured to receive location information.

20. The system of claim 12 wherein the event receiving component is configured to receive an event represented by XML.
